(19) United States
(12) Patent Application Publication
(10) Pub. No.: US 2009/0032676 A1
(43) Pub. Date: Feb. 5, 2009

(54) MOUNTING APPARATUS FOR AIR FRESHENER

(75) Inventor: KE-YOU HU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO.,LTD., Shenzhen City (CN); HON HAI PRECISION INDUSTRY CO., LTD., Taipei Hsien (TW)

(21) Appl. No.: 11/967,018

(22) Filed: Dec. 29, 2007

(30) Foreign Application Priority Data
Aug. 1, 2007 (CN) 200710201247.X

(51) Int. Cl. F16M 11/00

(52) U.S. Cl. 248/682

(57) ABSTRACT

A mounting apparatus for securely fixing an air freshener such as a fragrance bag includes a panel of a computer and a fixing box accommodating the fragrance bag. One end of the box is pivotably mounted to the panel, and the other end is detachably fixed to the panel. Because of the mounting apparatus, the fragrance bag can't drop from the fixing box even when the computer is moved.

### BACKGROUND

1. Field of the Invention

The present invention relates to mounting apparatuses and especially to a mounting apparatus for fixing air freshener for an electronic device.

2. Description of Related Art

Nowadays, electronic devices such as computers are widely used in many fields. If users operate electronic devices for a long time, they may feel tired, thereby influencing their health and working efficiency. Medical experts have found that certain fragrances can have a beneficial influence on productivity of people in the workplace. Therefore, a computer with a fragrance emitting apparatus therein is invented. The fragrance emitting apparatus includes a case, a heat conducting board mounted in the case, a fragrance container containing a fragrance material disposed in the case and contacting the heat conducting board. However, should the computer be moved, the fragrance material or the fragrance container can easily drop out from the computer.

What is desired, therefore, is a mounting apparatus which securely holds a fragrance material or a fragrance container.

### SUMMARY

An exemplary mounting apparatus for securely fixing an air freshener such as a fragrance bag includes a panel of a computer and a fixing box accommodating the fragrance bag. One end of the box is pivotably mounted to the panel, and the other end is detachably fixed to the panel. Because of the mounting apparatus, the fragrance bag can't drop from the fixing box even when the computer is moved.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a mounting apparatus in accordance with an embodiment of the present invention together with a fragrance bag;

FIG. 2 is an isometric view of a box of FIG. 1, but viewed from another aspect; and

FIG. 3 is an assembled view of FIG. 1.

### DETAILED DESCRIPTION

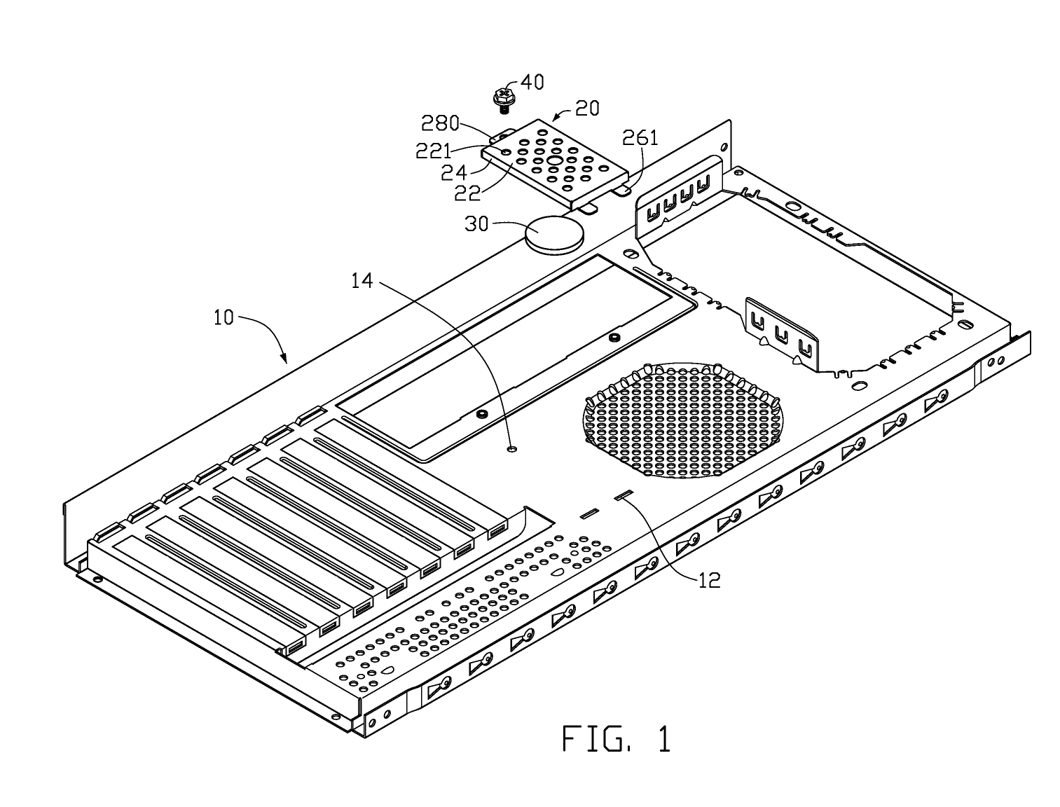

Referring to FIG. 1, a mounting apparatus in accordance with an embodiment of the present invention is provided for fixing an air freshener such as a fragrance bag 30, containing a fragrance material, to a computer enclosure. The mounting apparatus includes a rear panel 10 of the computer, and a fixing box 20.

The panel 10 defines a pair of aligned rectangular holes 12 and a positioning hole 14 offset from the holes 12.

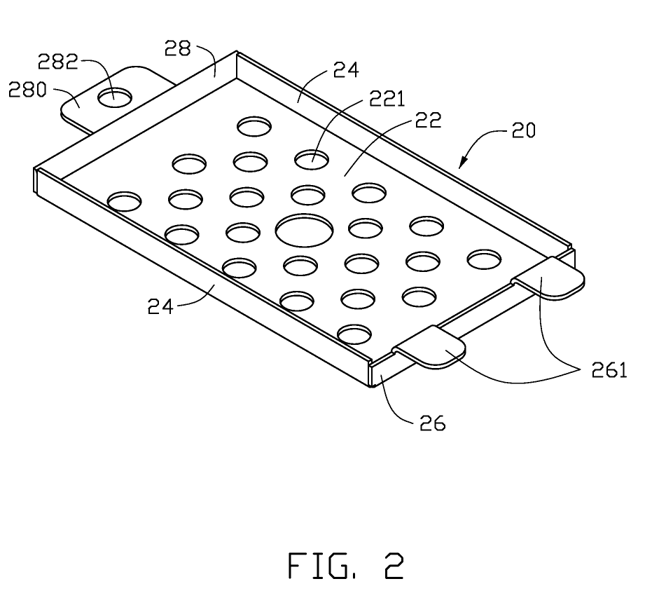

Referring to FIG. 2, the fixing box 20 is shaped like an shallow box having no cover. The fixing box 20 includes a base plate 22 defining a plurality of through holes 221 therein, a pair of side plates 24 extending perpendicularly from the two opposite longitudinal edges of the base plate 22 respectively, and a pair of mounting plates 26. 28 extending perpendicularly from the other edges of the base plate 22 respectively, and respectively coupled to the ends of the side plates 24. The base plate 22, the side plates 24, and the mounting plates 26, 28 cooperate to form a receiving room for holding the fragrance bag 30. The top edge of the mounting plate 26 is lower than the top edges of the side plates 24. A pair of latching tabs 261 extends out from a free edge of the side plate 24 for engaging in the holes 12 respectively, and the latching tabs 261 are substantially coplanar with the free edges of the side plates 24. The mounting plate 28 is substantially coplanar with the free edges of the side plates 24, and a tab 280 extends outside from the free edge of the mounting plate 28. The tab 280 defines a fastener hole 282 corresponding to the positioning hole 14.

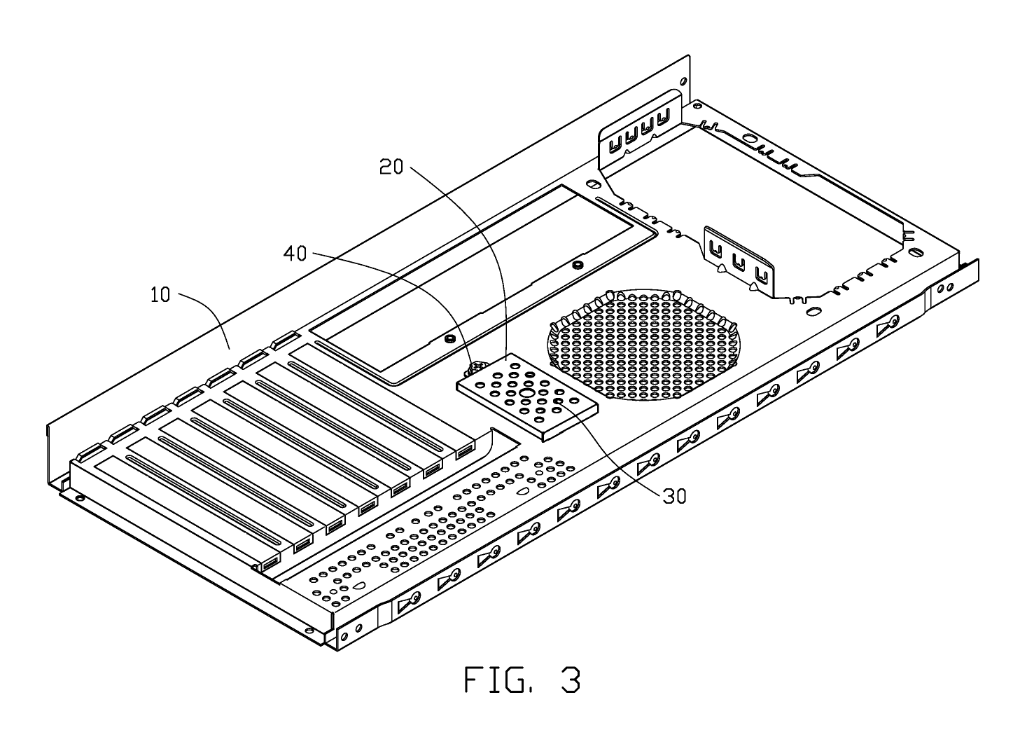

Referring to FIG. 3, in assembly, the latching tabs 261 of the fixing box 20 are respectively passed through the holes 12 from the interior of the panel 10. The end of the fixing box 20 adjacent the tab 280is spaced from the panel 10, and the fragrance bag 30 is located in the fixing box 20. The fixing box 20 is rotated around the latching tabs 261 to adjust the tab 280 until the screw hole 282 of the tab 280 is aligned with the positioning hole 14 of the panel 10. A fastener such as a screw 40 is passed through the hole 282 and engaged in the positioning hole 14 to fix the fixing box 20 to the panel 10.

In another embodiment of the invention, a pair of clips extends oppositely from the panel 10 respectively defining a through hole therein. A pair of shafts extends oppositely from an end of the side plate 24 of the fixing box 20. The shafts are respectively passed through the through holes, thus the fixing box 20 is pivotably fixed to the panel 10.

The fixing box 20 can be fixed to the panel at a position adjacent a heat-generating component or a position where heated air passes through. When the computer is working, electronic devices such as central processing units (CPUs) of the computer generate heat, which heats the fragrance material in the fragrance bag 30 thus emitting fragrance.

If the fragrance material is used up, people can first release the screw 30, and then rotate the fixing box 20 to detach it from the panel 10 and replace the fragrance material in the fragrance bag 30.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment.

What is claimed is:

1. A mounting apparatus for air freshener comprising:
a panel; and
a fixing box configured to receive an air freshener, one end of the fixing box pivotably mounted to the panel, the other end detachably fixed to the panel.

2. The mounting apparatus as claimed in claim 1, wherein the fixing box comprises a base plate defining a plurality of through holes therein, a pair of side plates extending perpendicularly from the two opposite longitudinal edges of the base plate respectively, a pair of mounting plates extending perpendicularly from the other two edges of the base plate respectively, and respectively coupled to the edges of the pair of side plates to form a receiving room for holding the perfume.

3. The mounting apparatus as claimed in claim 2, wherein the panel defines at least one hole; and at least one latching tab extending from one of the pair of mounting plates of the fixing box engaging in the at least one hole of the panel.

4. The mounting apparatus as claimed in claim 1, wherein a pair of clips extends oppositely from the panel respectively, each defining a through hole therein, a pair of shafts extend oppositely from a end of the fixing box respectively, the shafts are respectively passed through the through holes to pivotably fix the fixing box to the panel.

5. The mounting apparatus as claimed in claim 1, wherein the panel defines a positioning hole, a tab extends from the other end of the fixing box; and the tab defines a fastener hole therein corresponding to the positioning hole of the panel for fixing the fixing box.
